(19) United States
(12) Patent Application Publication
(10) Pub. No.: US 2025/0367758 A1
(43) Pub. Date: Dec. 4, 2025

(54) LASER PROCESSING SYSTEM, AND LASER PROCESSING METHOD

(71) Applicant: FANUC CORPORATION, Minamitsuru-gun, Yamanashi (JP)

(72) Inventor: Takashi IZUMI, Minamitsuru-gun, Yamanashi (JP)

(73) Assignee: FANUC CORPORATION, Minamitsuru-gun, Yamanashi (JP)

(21) Appl. No.: 18/875,294

(22) PCT Filed: Jun. 28, 2022
(86) PCT No.: PCT/JP2022/025800

§ 371 Date: Dec. 16, 2024

(51) Int. Cl. B23K 26/08; B23K 26/04; B23K 26/70

(52) U.S. Cl. CPC B23K 26/0884; B23K 26/04; B23K 26/702

(57) ABSTRACT

A laser processing includes: a laser processing head; a robot for moving the laser processing head; a distance measuring sensor for measuring a distance between the laser processing head and a workpiece; a control device for controlling a laser emission operation of the laser oscillator and a movement operation of the robot; and a mode selection switch for selecting an operating mode for the laser processing. The control device executes the laser emission operation and the movement operation as the automatic operating mode if the automatic operating mode is selected by the mode selection switch and the distance measured by the distance measuring sensor is within a predetermined range.

### CROSS REFERENCE TO RELATED APPLICATIONS

This is the U.S. National Phase application of PCT/JP2022/025800, filed Jun. 28, 2022, the disclosure of this application being incorporated herein by reference in its entirety for all purposes.

### FIELD OF THE INVENTION

The present disclosure relates to a laser processing system and a laser processing method.

### BACKGROUND OF THE INVENTION

A laser processing system for performing a laser process on a workpiece is known (e.g., Patent Literature 1).

### PATENT LITERATURE

PTL 1: JP 2015-167974 A

### SUMMARY OF THE INVENTION

In the laser processing system, a laser process may be executed in an automatic drive mode in which a robot and a laser oscillator are automatically driven in accordance with a processing program. Such automatic drive is required to ensure work safety.

In one aspect of the present disclosure, a laser processing system configured to perform a laser process on a workpiece, the laser processing system includes: a laser processing head configured to emit a laser beam generated by a laser oscillator; a robot configured to move the laser processing head relative to the workpiece; a distance measurement sensor configured to measure a distance between the laser processing head and the workpiece; a controller configured to control a laser emission operation of operating the laser oscillator to emit a laser beam from the laser processing head, and a movement operation of operating the robot to move the laser processing head relative to the workpiece; and a mode selection switch configured to select a drive mode of the laser process.

The controller is configured to, when an automatic drive mode, in which the laser emission operation and the movement operation are automatically executed in accordance with a processing program, is selected as the drive mode by the mode selection switch, and when the distance measured by the distance measurement sensor is within a predetermined range, execute the laser emission operation and the movement operation as the automatic drive mode.

### BRIEF DESCRIPTION OF THE DRAWINGS

FIG. 1 is a schematic diagram of a laser processing system according to an embodiment.

FIG. 2 is a block diagram of the laser processing system illustrated in FIG. 2.

FIG. 3 is an enlarged view of a laser processing head illustrated in FIG. 1.

FIG. 4 is an enlarged view of a mode selection switch illustrated in FIG. 1.

FIG. 5 is a view for explaining a function of a contact detection device illustrated in FIG. 2.

FIG. 6 is a flowchart showing an example of an operation flow of a laser processing head illustrated in FIG. 2.

FIG. 7 is a flowchart showing an example of a flow of step S2 in FIG. 6.

FIG. 8 is a flowchart showing an example of a flow of step S3 in FIG. 6.

FIG. 9 is a block diagram illustrating another function of the laser processing system illustrated in FIG. 2.

FIG. 10 is a flowchart showing another example of the flow of step S3 in FIG. 6.

FIG. 11 is a flowchart showing still another example of the flow of step S3 in FIG. 6.

FIG. 12 is a flowchart showing an example of an operation flow of the laser processing system illustrated in FIG. 9.

FIG. 13 is an enlarged view of a mode selection switch according to another embodiment.

FIG. 14 is a flowchart showing an example of a flow of step S2 in FIG. 12.

FIG. 15 is a flowchart showing an example of a flow of step S3 in FIG. 12.

FIG. 16 is a flowchart showing an example of a flow of step S5 in FIG. 12.

FIG. 17 illustrates an example of a mode selection switch image.

FIG. 18 is a schematic diagram of a laser processing system according to another embodiment.

FIG. 19 is a block diagram of the laser processing system illustrated in FIG. 18.

### DETAILED DESCRIPTION OF EMBODIMENTS OF THE INVENTION

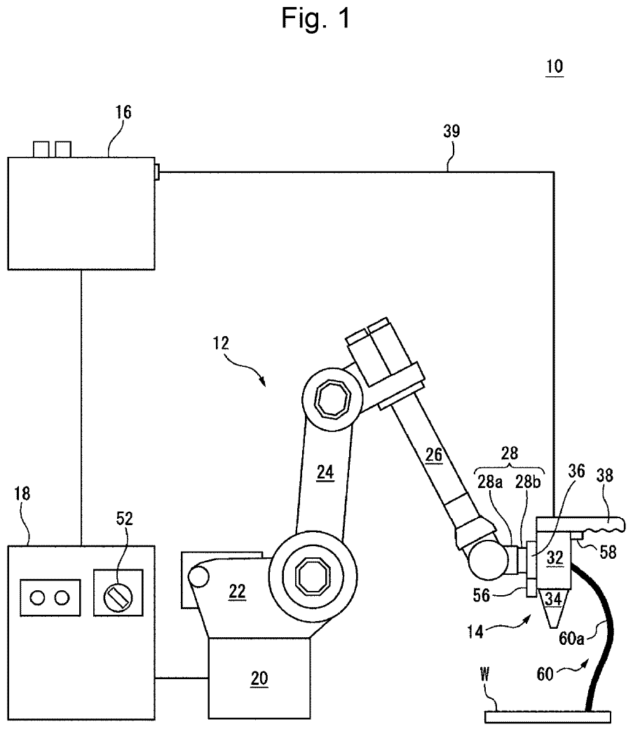

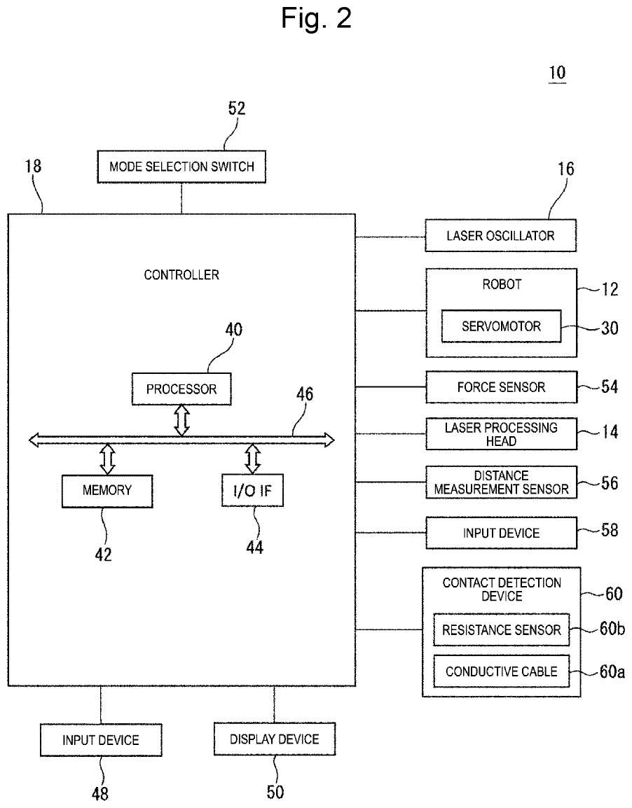

Embodiments of the present disclosure will be described in detail below based on the drawings. Note that, in the various embodiments described below, similar elements are denoted by the same signs, and redundant descriptions are omitted. First, a laser processing system 10 according to an embodiment will be described with reference to FIG. 1 and FIG. 2. The laser processing system 10 is a system that can execute a laser process (laser welding, laser cutting, and the like) on a workpiece W in cooperation with an operator.

Specifically, the laser processing system 10 includes a robot 12, a laser processing head 14, a laser oscillator 16, and a controller 18. A robot 12 moves the laser processing head 14 relative to the workpiece W. In the present embodiment, the robot 12 is a vertical articulated robot and includes a robot base 20, a swivel body 22, a lower arm 24, an upper arm 26, and a wrist 28.

The robot base 20 is fixed on a floor of a work cell. The swivel body 22 is provided at the robot base 20 being turnable around the vertical axis. The lower arm 24 is provided at the swivel body 22 so as to be rotatable about a horizontal axis. The upper arm 26 is rotatably provided at the distal end portion of the lower arm 24. The wrist 28 includes a wrist base 28a provided at a distal end portion of the upper arm 26 so as to be rotatable around two axes perpendicular to each other, and a wrist flange 28b rotatably provided at the wrist base 28a.

The components of the robot 12 (i.e., the robot base 20, the swivel body 22, the lower arm 24, the upper arm 26, and the wrist 28) are respectively provided with a plurality of servomotors 30 (FIG. 2). The servomotors 30 cause each of the movable components (the swivel body 22, the lower arm 24, the upper arm 26, the wrist 28, and the wrist flange 28b) of the robot 12 to rotate about a drive axis in response to a command from the controller 18. Due to this, the robot 12 moves the laser processing head 14 relative to the workpiece W.

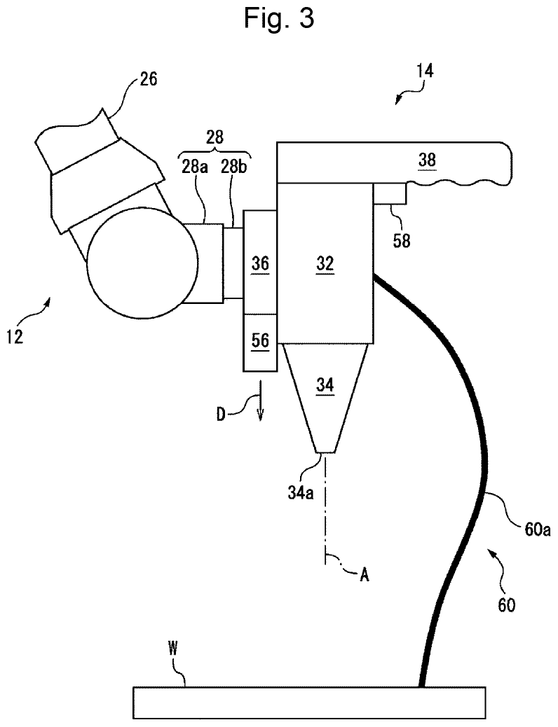

The laser processing head 14 is detachably attached to the wrist flange 28b of the robot 12, and emits a laser beam LB generated by the laser oscillator 16. Specifically, as illustrated in FIG. 3, the laser processing head 14 includes a head main body 32, a nozzle 34, an attachment tool 36, and a grip 38. The head main body 32 is made to be hollow and accommodates therein optical system components such as an optical lens (such as a collimator lens or a focus lens) and a lens drive part (e.g., a servomotor) that displaces the optical lens in response to a command from the controller 18.

The nozzle 34 is made to be hollow, and is provided at a distal end portion of the head main body 32. The nozzle 34 has a truncated conical outline with a cross-sectional area that decreases from a base end portion toward a distal end portion thereof, and an exit port 34a is formed at the distal end portion. A hollow chamber is formed inside the head main body 32 and the nozzle 34, and an assist gas AG is supplied into the chamber from an externally provided assist gas supply device (not illustrated). The laser beam LB generated by the laser oscillator 16 propagates in the chamber and is emitted from the exit port 34a along an optical axis A together with the assist gas AG.

The attachment tool 36 is provided at the head main body 32, and is attached to and detached from the wrist flange 28b of the robot 12. As an example, the attachment tool 36 may include a fastener such as a bolt and may be fastened to the wrist flange 28b by the fastener. As another example, the attachment tool 36 may include an engaging portion detachably engaged with an engaged portion formed on the wrist flange 28b, and may be attached to and detached from the wrist flange 28b by engagement between the engaged portion and the engaging portion. As still another example, the attachment tool 36 may include an electromagnet, and may be chucked and fixed to the wrist flange 28b by an electromagnetic force generated by the electromagnet. The laser processing head 14 is detachably attached to the wrist flange 28b of the robot 12 via this attachment tool 36.

The grip 38 is provided integrally with a base end portion of the head main body 32 so that the grip 38 is grippable by an operator with one hand. The grip 38 may have an uneven portion corresponding to a finger of the one hand in order to enable the operator to grip with one hand. The operator grips the grip 38 and removes the laser processing head 14 from the wrist flange 28b, whereby the operator can carry the laser processing head 14.

With reference to FIG. 1 and FIG. 2, the laser oscillator 16 internally performs laser oscillation in response to a command (laser power command or the like) from the controller 18, and generates the laser beam LB. The laser oscillator 16 may be of any type such as a fiber laser oscillator, a pulse laser oscillator, a direct diode laser (DDL), a CO₂ laser oscillator, or a solid-state laser (YAG laser) oscillator. The laser oscillator 16 supplies the generated laser beam LB to the laser processing head 14 via a light guide path 39. The light guide path 39 may be composed of an optical fiber, a hollow, a light guide material such as crystal, a reflecting mirror, or an optical lens.

The controller 18 controls a laser emission operation LO of operating the laser oscillator 16 to emit the laser beam LB from the laser processing head 14, and a movement operation MO of operating the robot 12 to move, relative to the workpiece W, the laser processing head 14 attached to the robot 12.

Specifically, as illustrated in FIG. 2, the controller 18 is a computer including a processor 40, a memory 42, and an I/O interface 44. The processor 40 includes a CPU or a GPU, is communicably connected to the memory 42 and the I/O interface 44 via a bus 46, and executes various types of arithmetic processing to execute a laser process described below while communicating with these components. The memory 42 includes a RAM or a ROM and temporarily or permanently stores various types of data used for the arithmetic processing executed by the processor 40 and various types of data generated during the arithmetic processing.

The I/O interface 44 includes, for example, an Ethernet (registered trademark) port, a USB port, an optical fiber connector, or an HDMI (registered trademark) terminal, and performs wired or wireless data communication with an external apparatus under a command from the processor 40. The robot 12 (specifically, each servomotor 30), the laser processing head 14 (specifically, the lens drive part), and the laser oscillator 16 are communicatively connected to the I/O interface 44.

The controller 18 is further provided with an input device 48 and a display device 50. The input device 48 includes a keyboard, a mouse, or a touchscreen, and receives an input of data from an operator. The display device 50 includes a liquid crystal display or an organic EL display and displays various types of data.

The input device 48 and the display device 50 are connected to the I/O interface 44 so as to be able to communicate in a wired or wireless manner. Note that the input device 48 and the display device 50 may be integrated into a housing of the controller 18, or may be provided separately from the housing of the controller 18 as one computer (PC or the like), for example.

The laser processing system 10 further includes a mode selection switch 52, a force sensor 54 (FIG. 2), a distance measurement sensor 56, an input device 58, and a contact detection device 60. The mode selection switch 52 is for selecting a drive mode DM of the laser process executed by the controller 18. In the present embodiment, the mode selection switch 52 is provided integrally with the controller 18.

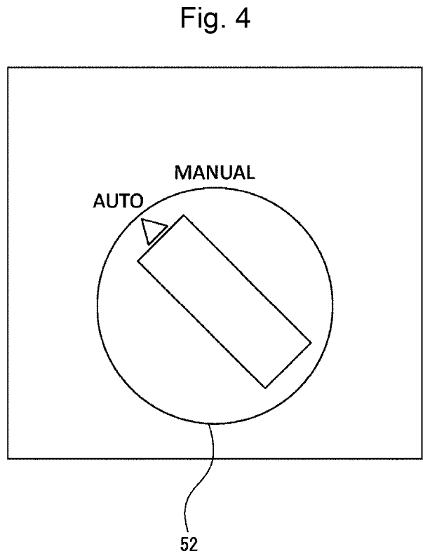

More specifically, as illustrated in FIG. 4, the mode selection switch 52 is configured to switch the drive mode DM between an automatic drive mode DM1 represented as “AUTO” and a manual drive mode DM2 represented as “MANUAL”. The automatic drive mode DM1 is the drive mode DM in which the processor 40 of the controller 18 automatically executes the laser emission operation LO and the movement operation MO in accordance with a processing program PP created in advance.

Specifically, upon receiving an automatic drive start command CM1 described later, the processor 40 sequentially generates commands to the laser oscillator 16 in accordance with the processing program PP, and automatically execute the laser emission operation LO of operating the laser oscillator 16 in accordance with the commands to emit the laser beam LB from the laser processing head 14.

Together with the laser emission operation LO, the processor 40 sequentially generates commands (position command, speed command, torque command, and the like) to the robot 12 (specifically, each servomotor 30) in accordance with the processing program PP, and automatically executes the movement operation MO of operating the robot 12 in accordance with the commands to move the laser processing head 14 relative to the workpiece W.

This processing program PP is created by the operator and stored in the memory 42 in advance. Note that the processing program PP may include a first processing program PP_{A} that defines the operation of the laser oscillator 16 and a second processing program PP_{B} that defines the operation of the robot 12.

On the other hand, the manual drive mode DM2 is the drive mode DM in which the operator grips and carries the laser processing head 14 by hand, manually causes the controller 18 to execute the laser emission operation LO, and manually performs a laser process on the workpiece W with the laser beam LB emitted from the laser processing head 14. In this manual drive mode DM2, the operator manually gives a manual laser emission command CM2 described later to the controller 18, and the processor 40 of the controller 18 executes the laser emission operation LO in response to the manual laser emission command CM2.

By operating the mode selection switch 52, the operator can switch the drive mode DM between the automatic drive mode DM1 and the manual drive mode DM2. FIG. 4 illustrates a state in which the automatic drive mode DM1 (“AUTO”) is selected by the mode selection switch 52.

When the automatic drive mode DM1 is selected by the mode selection switch 52, the mode selection switch 52 supplies an automatic drive mode transition command CM3 to the controller 18. On the other hand, when the manual drive mode DM2 is selected by the mode selection switch 52, the mode selection switch 52 supplies a manual drive mode transition command CM4 to the controller 18. The automatic drive mode transition command CM3 and the manual drive mode transition command CM4 may be ON/OFF signals (e.g., automatic drive mode transition command CM3: ON signal or “1” signal, manual drive mode transition command CM4: OFF signal or “0” signal).

The force sensor 54 (FIG. 2) is provided at the robot 12 and detects an external force F applied to the robot 12. As an example, the force sensor 54 is provided at each servomotor 30 of the robot 12, and includes a plurality of torque sensors 54A configured to detect torque applied to an output shaft of the servomotor 30.

As another example, the force sensor 54 is provided at a component (e.g., the robot base 20 or the wrist 28) of the robot 12, and includes a six-axis force sensor 54B capable of detecting a force in the six-axis direction. The processor 40 of the controller 18 can obtain the magnitude and direction of the external force F applied to the robot 12 based on detection data DF of the force sensor 54, and can specify the part (e.g., wrist 28) of the robot 12 applied with the external force F.

The distance measurement sensor 56 measures a distance d between the laser processing head 14 (e.g., exit port 34a) and the workpiece W. Specifically, the distance measurement sensor 56 is a distance measurement sensor of, for example, a capacitance type, an infrared type, a laser type, or a sound wave type (e.g., an ultrasonic type). For example, in the case of the capacitance type, the distance measurement sensor 56 is provided at the head main body 32 (or the nozzle 34) so as to measure the distance to an object present at a position closest to the laser processing head 14.

On the other hand, in the case of the infrared type, the laser type, or the sound wave type, the distance measurement sensor 62 is attached to the head main body 32 (or the nozzle 34) of the laser processing head 14 such that the measurement direction D (in other words, the radiation direction of the infrared ray, the laser, or the sound wave) for measuring the distance d to the object is parallel to the optical axis A. That is, in this case, the distance measurement sensor 56 measures the distance d between the laser processing head 14 (exit port 34a) and the workpiece W in the direction of optical axis A. The input device 58 receives an input operation of the manual laser emission command CM2 for causing the processor 40 of the controller 18 to execute the laser emission operation LO. Specifically, the input device 58 includes a press button, a switch, or a touchscreen that the operator enables an input operation by hand, and is provided at the laser processing head 14 (e.g., the head main body 32 or the grip 38). Upon receiving the input operation by the operator, the input device 58 supplies the manual laser emission command CM2 to the controller 18. The manual laser emission command CM2 may be an ON signal (or “1” signal).

Upon receiving the manual laser emission command CM2 during execution of the manual drive mode DM2, the processor 40 of the controller 18 executes the laser emission operation LO in response to the manual laser emission command CM2. Thus, as the manual drive mode DM1, the operator can manually perform the laser process on the workpiece W by the laser beam LB emitted from the exit port 34a of the laser processing head 14 while carrying the laser processing head 14 by hand. In the present embodiment, the input device 58 is provided at the laser processing head 14 adjacent to the grip 38 so that the operator can perform the input operation with one hand gripping the grip 38.

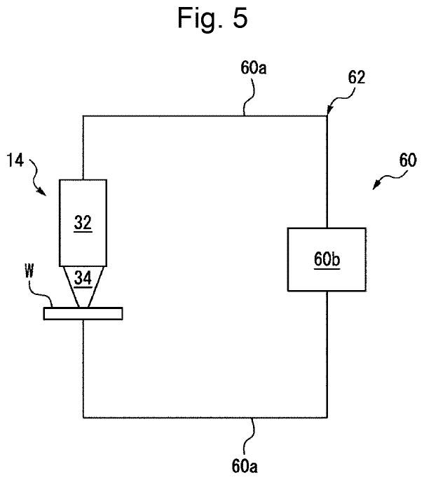

The contact detection device 60 detects whether the laser processing head 14 and the workpiece W are in contact or in non-contact. Specifically, the contact detection device 60 includes a conductive cable 60a and a resistance sensor 60b (FIGS. 2 and 5). The conductive cable 60a has one end electrically connected to the head main body 32 of the laser processing head 14, and the other end electrically connected to the workpiece W, thereby electrically connecting the laser processing head 14 and the workpiece W.

Here, in the present embodiment, at least a part of the head main body 32 and the nozzle 34 of the laser processing head 14 is made of a conductive material (e.g., metal). The workpiece W is made of metal (e.g., iron or copper). Therefore, if the distal end of the nozzle 34 of the laser processing head 14 comes into contact with the workpiece W, as illustrated in FIG. 5, the workpiece W, the head main body 32 and the nozzle 34 of the laser processing head 14, and the conductive cable 60a form a closed circuit 62.

The resistance sensor 60b measures a resistance R at the closed circuit 62 by applying this closed circuit 62 with a voltage. As illustrated in FIG. 5, when the laser processing head 14 and the workpiece W are in contact with each other, the resistance R measured by the resistance sensor 60b is an extremely small value R₀ (R₀≈0). On the other hand, when the laser processing head 14 and the workpiece W are in non-contact with each other (i.e., the distal end of the nozzle 34 is separated from the workpiece W), the resistance R measured by the resistance sensor 60b is an extremely large value R₁ (R₁≈∞>>R₀).

The contact detection device 60 can detect whether the laser processing head 14 and the workpiece W are in contact or in non-contact based on the resistance R measured by the resistance sensor 60b. The resistance sensor 60b supplies measurement data of the measured resistance R or contact determination data indicating contact or non-contact between the laser processing head 14 and the workpiece W to the controller 18 as detection data DD.

The processor 40 of the controller 18 can determine contact or non-contact between the laser processing head 14 and the workpiece W from the detection data DD of the resistance sensor 60b. The resistance sensor 60b may be incorporated in the head main body 32. Note that the force sensor 54, the distance measurement sensor 56, the input device 58, and the contact detection device 60 (resistance sensor 60b) may be connected to the I/O interface 44 of the controller 18 so as to be able to communicate in a wireless or wired manner.

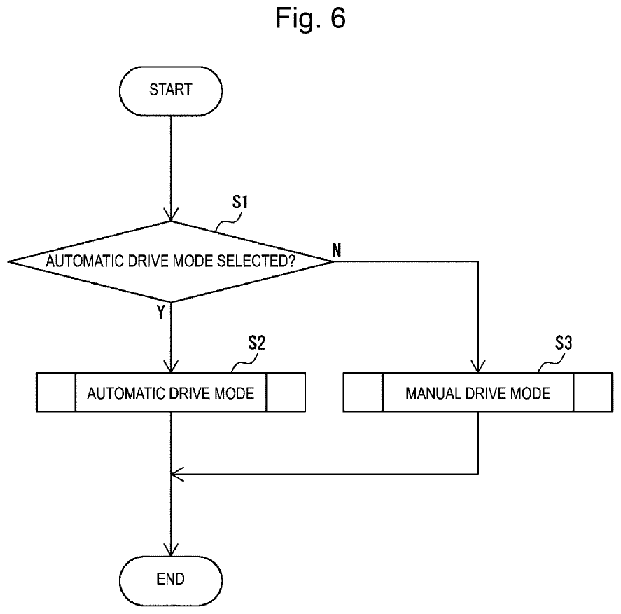

Next, the operation of the laser processing system 10 will be described with reference to FIG. 6. The processor 40 of the controller 18 starts the flow of FIG. 6 when receiving an operation start command (e.g., the power ON command) from, for example, the operator, a host controller, or an operation program OP.

In step S1, the processor 40 determines whether or not the automatic drive mode DM1 is selected by the mode selection switch 52. Specifically, the processor 40 determines whether the automatic drive mode transition command CM3 has been received or the manual drive mode transition command CM4 has been received from the mode selection switch 52. The processor 40 determines YES when receiving the automatic drive mode transition command CM3 and proceeds to step S2, and determines NO when receiving the manual drive mode transition command CM4 and proceeds to step S3.

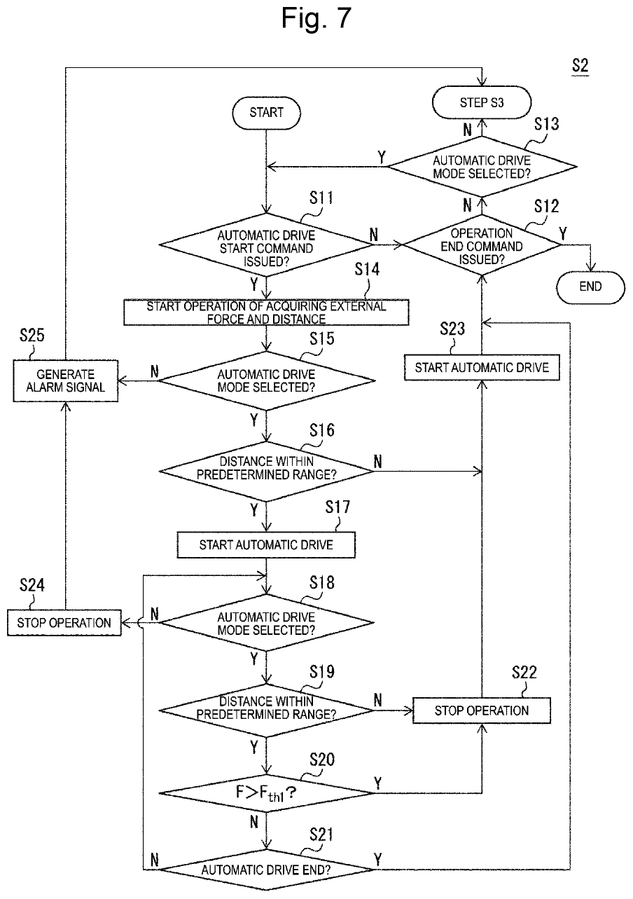

In step S2, the processor 40 transitions the drive mode DM to the automatic drive mode DM1 and executes the flow of the automatic drive mode DM1. After transitioning to the automatic drive mode DM1, the processor 40 is brought into a state of being able to receive the automatic drive start command CM1, and rejects the manual laser emission command CM2 supplied from the input device 58. Hereinafter, the flow of the automatic drive mode DM1 in step S2 will be described with reference to FIG. 7.

In step S11, the processor 40 determines whether or not the automatic drive start command CM1 for starting the automatic drive in the automatic drive mode DM1 has been received. Specifically, the processor 40 generates and displays, on the display device 50, an automatic drive start image IM1 (not illustrated) with a button image for starting the automatic drive.

The operator operates the input device 48 of the controller 18 to click, on the image, the button image displayed on the automatic drive start image IM1, thereby performing an input for giving the automatic drive start command CM1 to the processor 40. The processor 40 determines YES when receiving the automatic drive start command CM1, and proceeds to step S14, and proceeds to step S12 when determining NO.

In step S12, the processor 40 determines whether or not an operation end command (e.g., a shutdown command) has been received from, for example, the operator, the host controller, or the operation program OP. When receiving the operation end command, the processor 40 determines YES, and ends the flow of step S2 shown in FIG. 7, thereby ending the flow shown in FIG. 6. On the other hand, when determining NO, the processor 40 proceeds to step S13.

In step S13, the processor 40 determines whether or not the automatic drive mode DM1 is still selected by the mode selection switch 52. When determining YES, the processor returns to step S11. On the other hand, when determining NO (i.e., the mode selection switch 52 is operated to switch to the manual drive mode DM2), the processor 40 proceeds to step S3 in FIG. 6.

On the other hand, when determining YES in step S11, the processor 40 starts in step S14 an operation of acquiring the external force F applied to the robot 12 and an operation of acquiring the distance d between the laser processing head 14 and the workpiece W. Specifically, the processor 40 continuously (e.g., periodically) acquires the detection data DF from the force sensor 54, and continuously obtains the external force F applied to the robot 12 based on the detection data DF. The processor 40 continuously (e.g., periodically) acquires the distance d between the laser processing head 14 and the workpiece W measured by the distance measurement sensor 56. Thus, the processor 40 monitors the external force F and the distance d after the start of step S14.

In step S15, the processor 40 determines whether or not the automatic drive mode DM1 is still selected by the mode selection switch 52 similarly to step S13 described above. The processor 40 proceeds to step S16 when determining YES, and proceeds to step S25 when determining NO.

In step S16, the processor 40 determines whether or not the distance d between the laser processing head 14 and the workpiece W that is most recently acquired is within a predetermined range RG. For example, this range RG may be defined as a range of d≤dₜₕ (e.g., dₜₕ=3 mm), or may be defined as a range of [dₜₕ₁, dₜₕ₂] (e.g., dₜₕ₁=0.1 mm, dₜₕ₂=3 mm) (i.e., dₜₕ₁≤d≤dₜₕ₂). When the distance d is within the range RG, the processor determines YES and proceeds to step S17. On the other hand, when the distance d is out of the range RG, the processor 40 determines NO and proceeds to step S23.

In step S17, the processor 40 starts automatic drive. Specifically, the processor 40 reads and executes the processing program PP from the memory 42, and sequentially generates a command to the laser oscillator 16 and a command to the robot 12 in accordance with the processing program PP. Thus, the processor 40 starts an automatic drive of automatically executing the laser emission operation LO and the movement operation MO in accordance with the processing program PP.

As described above, in the present embodiment, when the condition that the automatic drive mode DM1 is selected by the mode selection switch 52 (YES is determined in step S15) and when the distance d measured by the distance measurement sensor 56 is within the range RG (YES is determined in step S16) is satisfied, the processor 40 executes the laser emission operation LO and the movement operation MO as the automatic drive mode DM1.

In step S18, the processor 40 determines whether or not the automatic drive mode DM1 is still selected by the mode selection switch 52 similarly to step S13 described above. The processor 40 proceeds to step S19 when determining YES, and proceeds to step S24 when determining NO.

In step S19, the processor 40 determines whether or not the distance d between the laser processing head 14 and the workpiece W that is most recently acquired is within the range RG, similarly to step S16 described above. The processor 40 proceeds to step S20 when determining YES, and proceeds to step S22 when determining NO.

In step S20, the processor 40 determines whether or not the external force F that is most recently acquired exceeds a predetermined threshold Fₜₕ₁ (F>Fₜₕ₁). The processor 40 determines YES when F>Fₜₕ₁, and proceeds to step S22, and determines NO when F≤Fₜₕ₁, and proceeds to step S21.

Based on the detection data DF of the force sensor 54, the processor 40 may monitor the external force F1 applied to a specific part (e.g., the upper arm 26 or the wrist 28) of the robot 12, and may determine YES when the external force F1 exceeds the threshold F1ₜₕ₁ (F1>F1ₜₕ₁) in step S20.

In step S21, the processor 40 determines whether or not the automatic drive has ended. For example, the processor 40 can determine whether or not all instruction codes for the laser emission operation LO and the movement operation MO defined in the processing program PP have been executed from the processing program PP being executed.

When determining YES, the processor returns to step S12, and when determining NO, the processor 40 returns to step S18. Thus, the processor 40 repeatedly executes the loop of steps S18 to S21 until determining NO in step S18 or S19 or determining YES in step S20 or S21, and continuously executes the laser emission operation LO and the movement operation MO as the automatic drive mode DM1.

On the other hand, when determining NO in step S19 or determining YES in step S20, the processor 40 stops at least one of the laser emission operation LO and the movement operation MO in the automatic drive mode DM1 in step S22. As an example, in step S22, the processor 40 stops both the laser emission operation LO and the movement operation MO.

Specifically, the processor 40 stops the operation of the servomotor 30 by stopping a command (torque command or the like) to each servomotor 30 of the robot 12, thereby stopping the movement operation MO. Alternatively, when a brake mechanism configured to brake the output shaft of each servomotor 30 is provided, the processor 40 may forcibly stop the operation of each servomotor 30 by actuating each brake mechanism, thereby stopping the movement operation MO.

By stopping the laser beam generation operation of the laser oscillator 16, the processor 40 stops the laser emission operation LO. Alternatively, when the laser oscillator 16 is provided with a shutter (not illustrated) configured to automatically open and close an optical path of the laser beam LB, the processor 40 may stop the laser emission operation LO by shielding the laser beam LB with the shutter.

As another example, the processor 40 may stop the laser emission operation LO and continue the movement operation MO in step S22 after determining NO in step S19, and stop both the laser emission operation LO and the movement operation MO in step S22 after determining YES in step S20.

As described above, in the present embodiment, the robot 12 is a cooperative robot that is capable of urgently stopping the movement operation MO in response to the external force F detected by the force sensor 54. In the case of the cooperative robot capable of urgent stop as described above, even if NO is determined in step S19, the safety of the operator can be ensured by stopping only the laser emission operation LO.

In step S23, the processor 40 generates an alarm signal AL. For example, in step S23 after determining NO in step S16 or S19, the processor 40 generates an alarm signal AL1 of an image or voice that “The workpiece is possibly not installed at an appropriate position relative to the laser processing head. Please check the installation state of the workpiece”.

On the other hand, in step S23 after determining YES in step S20, the processor 40 generates an alarm signal AL2 of an image or voice that, for example, “The robot possibly interferes with an environmental object. Please check the surroundings of the robot”. The processor 40 may display the generated alarm signal AL1 or AL2 as an image on the display device 50 or output the alarm signal AL1 or AL2 as a voice from a speaker (not illustrated) provided at the controller 18. After step S23, the processor 40 returns to step S12.

On the other hand, when determining NO in step S18, the processor 40 stops at least one of the laser emission operation LO and the movement operation MO in step S24 similarly to step S22 described above. For example, in step S24, the processor 40 stops both the laser emission operation LO and the movement operation MO.

In step S25, the processor 40 generates the alarm signal AL. For example, the processor 40 generates an alarm signal AL3 of an image or voice that “Automatic drive cannot be executed because drive mode is changed”. The processor 40 may display the generated alarm signal AL3 as an image on the display device 50 or output the alarm signal AL3 as a voice from the speaker. After step S25, the processor 40 proceeds to step S3 in FIG. 6.

With reference to FIG. 6 again, when determining NO in step S1 (alternatively, when determining NO in step S13 in FIG. 7, or after step S25), the processor 40 transitions the drive mode DM to the manual drive mode DM2 and executes the flow of the manual drive mode DM2 in step S3.

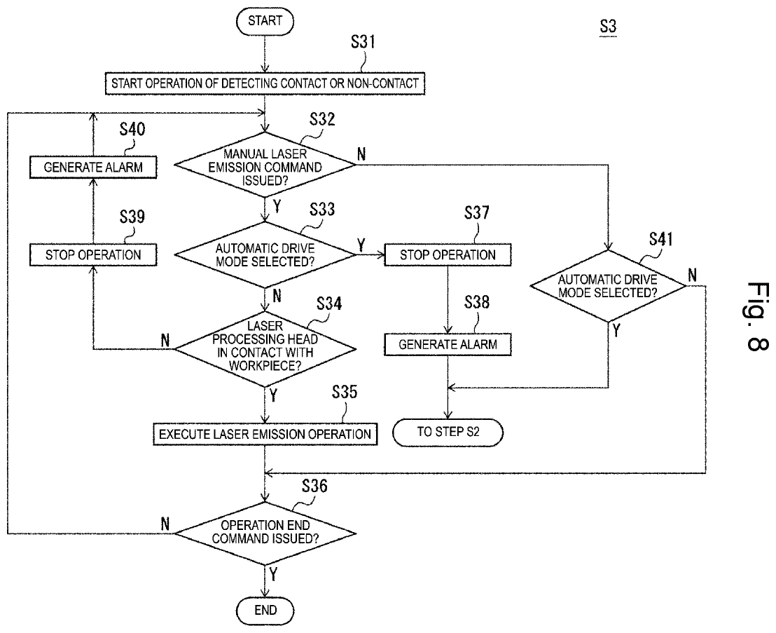

After transitioning to the manual drive mode DM2, the processor 40 is brought into a state of being able to receive the manual laser emission command CM2 supplied from the input device 58, and rejects the automatic drive start command CM1. Hereinafter, the flow of the manual drive mode DM2 in step S3 will be described with reference to FIG. 8.

In step S31, the processor 40 starts an operation of detecting contact or non-contact between the laser processing head 14 and the workpiece W by the contact detection device 60. Specifically, the processor 40 causes the resistance sensor 60b to measure the resistance R, and starts an operation of continuously (e.g., periodically) acquiring the detection data DD from the resistance sensor 60b.

In step S32, the processor 40 determines whether or not the manual laser emission command CM2 has been received from the input device 58. When receiving the manual laser emission command CM2 from the input device 58, the processor 40 determines YES and proceeds to step S33. On the other hand, when determining NO, the processor proceeds to step S41 without executing the laser emission operation LO in the manual drive mode DM2. If having executed the laser emission operation LO of step S35 described later at the start time point of step S32 and determining NO in step S32, the processor 40 stops the laser emission operation LO.

In step S33, the processor 40 determines whether or not the automatic drive mode DM1 is selected by the mode selection switch 52 similarly to step S1 described above. When determining YES (i.e., when the mode selection switch 52 is switched to the automatic drive mode DM1), the processor 40 proceeds to step S37. On the other hand, when determining NO (i.e., when the manual drive mode DM2 is still selected by the mode selection switch 52), the processor 40 proceeds to step S34.

In step S34, the processor 40 determines whether or not the laser processing head 14 and the workpiece W are in contact with each other. Specifically, based on the detection data DD most recently acquired from the resistance sensor 60b, the processor 40 determines whether the contact detection device 60 detects contact or non-contact between the laser processing head 14 and the workpiece W. When the contact between the laser processing head 14 and the workpiece W is detected, the processor 40 determines YES, and proceeds to step S35. On the other hand, when the non-contact between the laser processing head 14 and the workpiece W is detected, the processor determines NO, and proceeds to step S39.

In step S35, the processor 40 executes the laser emission operation LO as the manual drive mode DM2 in response to the manual laser emission command CM2 received through the input device 58. Here, in the present embodiment, a data table DT is stored in the memory 42 in advance, the data table DT in which a processing condition C_{P} of the workpiece W in the manual drive mode DM2 and an output condition C_{O} of the laser beam LB emitted by the laser emission operation LO in the manual drive mode DM2 are stored in association with each other.

The processing condition C_{P} includes, for example, a material (SUS, aluminum, and the like), a thickness [mm], and a melting point [° C.] of the workpiece W. On the other hand, the output condition C_{O} includes, for example, a laser power [kW], a duty ratio [%], and a pulse oscillation frequency [Hz] of the laser beam LB. The data table DT stores the output condition C_{O} (laser power, duty ratio, and pulse oscillation frequency) in association with each of the plurality of processing conditions C_{P} (material, thickness, and melting point).

The processor 40 sets the output condition C_{O} in the manual drive mode DM2 in advance based on the data table DT. As an example, the operator may manually select, from the data table DT, the output condition C_{O} corresponding to the processing condition C_{P} (e.g., material and thickness) of the workpiece W that is a processing target. In this case, the processor 40 may generate and display, on the display device 50, an image of the data table DT.

By operating the input device 48 of the controller 18 while visually recognizing the image of the data table DT, the operator searches the data table DT for, and selects, the output condition C_{O} corresponding to the processing condition C_{P} of the workpiece W that is a processing target. The processor 40 receives the operator's input through the input device 48, and sets, as the output condition in the manual drive mode DM2, the output condition C_{O} selected from the data table DT.

As another example, the operator may operate the input device 48 to input the processing condition C_{P} of the workpiece W that is a processing target. In this case, the processor 40 automatically searches the data table DT for the output condition C_{O} corresponding to the processing condition C_{P} input by the operator through the input device 48, and sets the searched output condition C_{O} as the output condition in the manual drive mode DM2. Thus, the processor 40 sets the output condition C_{O} in the manual drive mode DM2 in advance based on the data table DT.

In step S35, the processor 40 generates a command to the laser oscillator 16 in accordance with a preset output condition C_{O} in response to the manual laser emission command CM2, and executes the laser emission operation LO so as to generate the laser beam LB having the laser power, the duty ratio, and the pulse oscillation frequency defined in the output condition C_{O}. As a result, the operator can manually perform the laser process on the workpiece by emitting the laser beam LB under the desired output condition C_{O} from the laser processing head 14 gripped with one hand.

In step S36, the processor 40 determines whether or not an operation end command has been received, similarly to step S12 described above. When determining YES, the processor 40 ends the flow of step S3 shown in FIG. 8, and thus ends the flow shown in FIG. 6. On the other hand, when determining NO, the processor 40 returns to step S32.

Thus, while determining YES in step S32 (i.e., while receiving the manual laser emission command CM2 from the input device 58), the processor 40 repeatedly executes the loop of steps S33 to S36 until determining YES in step S32 or S36 or determining NO in step S34, and continuously executes the laser emission operation LO as the manual drive mode DM2. Thus, the operator can manually perform the laser process on the workpiece W by the laser processing head 14 gripped with the hand.

On the other hand, if YES is determined in step S33, the laser emission operation LO in the manual drive mode DM2 is stopped in step S37. For example, the processor 40 stops the laser beam generation operation of the laser oscillator 16 or shields the laser beam LB by the above-described shutter, thereby stopping the laser emission operation LO.

In step S38, the processor 40 generates the alarm signal AL. For example, the processor 40 generates an alarm signal AL4 of an image or voice that “Manual drive cannot be executed because drive mode is changed”. The processor 40 may display the generated alarm signal AL4 as an image on the display device 50 or output the alarm signal AL4 as a voice from the speaker. After step S38, the processor 40 proceeds to step S2 in FIG. 6.

On the other hand, when determining NO in step S34, the processor 40 stops the laser emission operation LO in the manual drive mode DM2 in step S39 similarly to step S37 described above. Then, in step S40, the processor 40 generates the alarm signal AL. For example, the processor 40 may generate an alarm signal AL5 of an image or voice that “Laser processing head is possibly separated from the workpiece. Please bring the laser processing head into contact with the workpiece” and display the alarm signal AL5 on the display device 50 or output the alarm signal ALS from the speaker. After step S40, the processor 40 returns to step S32.

On the other hand, when determining NO in step S32, the processor 40 determines in step S41 whether or not the automatic drive mode DM1 is selected by the mode selection switch 52 similarly to step S33 described above. The processor 40 proceeds to step S2 in FIG. 6 when determining YES, and proceeds to step S36 when determining NO.

As described above, in the present embodiment, when the automatic drive mode DM1, in which the laser emission operation LO and the movement operation MO are automatically executed in accordance with the processing program PP, is selected as the drive mode DM by the mode selection switch 52 (determining YES in step S15 or S18), and when the distance d measured by the distance measurement sensor 56 is within the predetermined range RG (determining YES in step S16 or S19), the controller 18 (specifically, the processor 40) executes the laser emission operation LO and the movement operation MO as the automatic drive mode DM1.

That is, in the present embodiment, in order to cause the controller 18 to execute the automatic drive of the laser emission operation LO and the movement operation MO in the automatic drive mode DM1, it is necessary for the operator to satisfy two conditions of manually operating the mode selection switch 52 to select the automatic drive mode DM1, and install the workpiece W at an appropriate position where the distance d is within the range RG relative to the laser processing head 14.

This configuration can reliably avoid the laser emission operation LO in the automatic drive mode DM1 from being unintentionally executed, and the laser beam LB from being emitted in an unintended direction (e.g., the direction of the operator) other than the workpiece W from the laser processing head 14 in the laser emission operation LO. Therefore, the automatic drive of the laser processing system 10 can be executed safely.

In the present embodiment, the input device 58 receives an input operation of the manual laser emission command CM2 for causing the controller 18 to execute the laser emission operation LO. The contact detection device 60 detects contact or non-contact between the laser processing head 14 and the workpiece W. The mode selection switch 52 is configured to switch the drive mode DM1 between the automatic drive mode DM1 and the manual drive mode DM2.

Then, the controller 18 executes the laser emission operation LO as the manual drive mode DM2 in response to the manual laser emission command CM2 received through the input device 58 when the manual drive mode DM2 is selected by the mode selection switch 52 and the contact detection device 60 detects contact between the laser processing head 14 and the workpiece W.

That is, in the present embodiment, in order to cause the controller 18 to execute the laser emission operation LO in the manual drive mode DM2, the operator needs to satisfy two conditions of manually operating the mode selection switch 52 to select the manual drive mode DM2 and bringing the laser processing head 14 into contact with the workpiece W.

This configuration can reliably avoid the laser emission operation LO in the manual drive mode DM2 from being unintentionally executed, and the laser beam LB from being emitted in a direction (e.g., the direction of the operator) other than the workpiece W from the laser processing head 14 in the laser emission operation LO. Therefore, the operator can safely execute the manual laser process.

In the present embodiment, the contact detection device 60 includes the conductive cable 60a configured to electrically connect the laser processing head 14 and the workpiece W, and the resistance sensor 60b configured to measure the resistance R of the closed circuit 62 formed by the workpiece W, the laser processing head 14 in contact with the workpiece W, and the conductive cable 60a.

Thus, the contact detection device 60 is configured to detect contact or non-contact between the laser processing head 14 and the workpiece W based on the resistance R measured by the resistance sensor 60b. According to this configuration, contact or non-contact between the laser processing head 14 and the workpiece W can be quickly and reliably detected with a relatively simple configuration.

In the present embodiment, the controller 18 stops the laser emission operation LO when the mode selection switch 52 is operated to deselect the manual drive mode DM2 (YES is determined in step S33) or the contact detection device 60 detects non-contact (NO is determined in step S34) during execution of the laser emission operation LO in the manual drive mode DM2.

This configuration can prevent the laser beam LB from the laser processing head 14 from being emitted in an unintended direction (e.g., the direction of the operator) when the mode selection switch 52 is unintentionally switched to another drive mode DM (specifically, the automatic drive mode DM1) during execution of the laser emission operation LO in the manual drive mode DM2.

It is possible to prevent the laser processing head 14 from being separated from the workpiece W and the laser beam LB from the laser processing head 14 from being emitted in an unintended direction during execution of the laser emission operation LO in the manual drive mode DM2. This can ensure the safety of the operator in the manual drive mode DM1 more reliably.

In the present embodiment, the laser processing head 14 has the grip 38 that is grippable by the operator with one hand, and the input device 58 is provided at the laser processing head 14 adjacent to the grip 38 so as to enable the input operation with the one hand gripping the grip 38. According to this configuration, the operator can easily execute the laser emission operation LO in the manual drive mode DM1 by gripping the grip 38 with one hand, removing the laser processing head 14 from the robot 12, and operating the input device 58 with the one hand.

In the present embodiment, the controller 18 does not start at least one (e.g., both) of the laser emission operation LO and the movement operation MO as the automatic drive mode DM1 when the automatic drive mode DM1 is deselected by the mode selection switch 52 (NO is determined in step S15) or the distance d measured by the distance measurement sensor 56 is out of the range RG (NO is determined in step S16) when the automatic drive start command CM1 for starting the automatic drive mode DM1 is received (YES is determined in step S11). With this configuration, the safety of the operator can be reliably ensured when the automatic drive starts.

When receiving the automatic drive start command CM1, the processor 40 may start the laser emission operation LO or the movement operation MO as the automatic drive mode DM1 even when the automatic drive mode DM1 is deselected by the mode selection switch 52 or the distance d is out of the range RG.

Specifically, when the robot 12 is a cooperative robot capable of urgent stop as described above, even when the automatic drive mode DM1 is deselected by the mode selection switch 52 or the distance d is out of the range RG, the safety of the operator can be ensured even if the movement operation MO is started as the automatic drive mode DM1. Alternatively, when the operator is present outside a safety fence (not illustrated) installed in a work cell so as to surround the operation range of the robot 12, the safety of the operator can be ensured even if the laser emission operation LO is started as the automatic drive mode DM1.

In the present embodiment, the controller 18 stops at least one of the laser emission operation LO and the movement operation MO (steps S22 and S24) when the mode selection switch 52 is operated to deselect the automatic drive mode DM1 (NO in step S18) or the distance d measured by the distance measurement sensor 56 is out of the range RG (NO in step S19), during execution of the laser emission operation LO and the movement operation MO as the automatic drive mode DM1. With this configuration, the safety of the operator during the automatic drive can be reliably ensured.

The input device 58 and the contact detection device 60 may be left out from the laser processing system 10. Only the automatic drive mode DM1 may be set as the drive mode DM, and the mode selection switch 52 may be configured to be selectable of the automatic drive mode DM1 and an OFF mode in which any drive mode DM is not selected. In this case, the processor 40 may execute only the flow of the automatic drive mode DM1 in step S2.

Steps S15 and S16 may be omitted from the flow of step S2. Alternatively, steps S18 and S19 may be omitted from the flow of step S2. Note that the contact detection device 60 is not limited to the form including the conductive cable 60a and the resistance sensor 60b, and may include any sensor such as a proximity sensor capable of detecting contact between the laser processing head 14 and the workpiece W, for example.

Note that the processor 40 may execute a cooperative operation program COP that causes the robot 12 to execute a cooperative operation for assisting a manual laser process by the operator during execution of the manual drive mode DM2. This cooperative operation program COP may be configured to cause the robot 12 to execute a cooperative operation of holding and moving (e.g., rotating) the workpiece W or loading the workpiece W onto a jig while the operator is manually executing the laser process, for example.

In this case, the wrist 28 of the robot 12 may be attached with a robot hand capable of holding the workpiece W in addition to (or in place of) the laser processing head 14. With this configuration, the operator can effectively execute the manual laser process in cooperation with the robot 12.

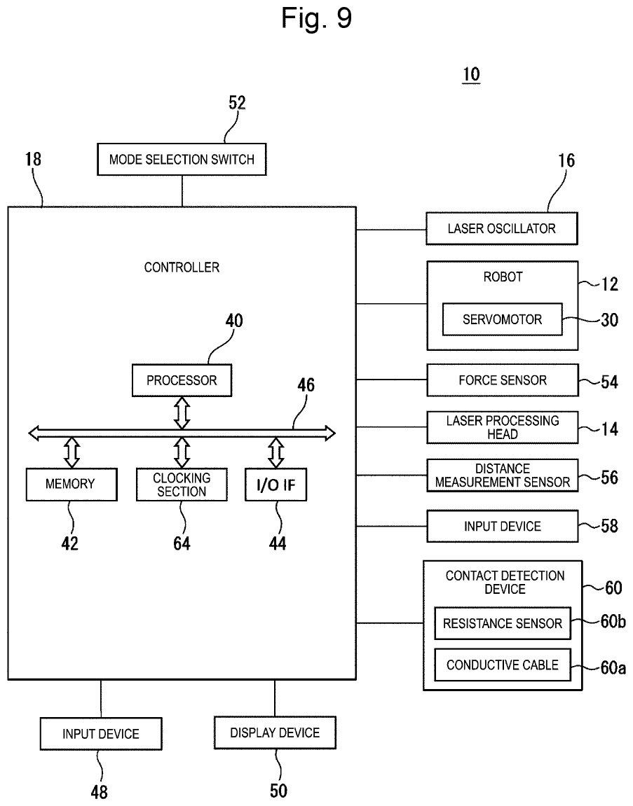

Next, other functions of the laser processing system 10 will be described with reference to FIG. 9. In the present embodiment, the controller 18 further includes a clocking section 64. The clocking section 64 is communicably connected to the processor 40 via the bus 46, and clocks an elapsed time t from a certain time point in response to a command from the processor 40. Note that the clocking section 64 may be incorporated in the housing of the controller 18. Alternatively, the clocking section 64 may be externally attached to the housing of the controller 18 and connected to the I/O interface 44 as an electronic clock, for example.

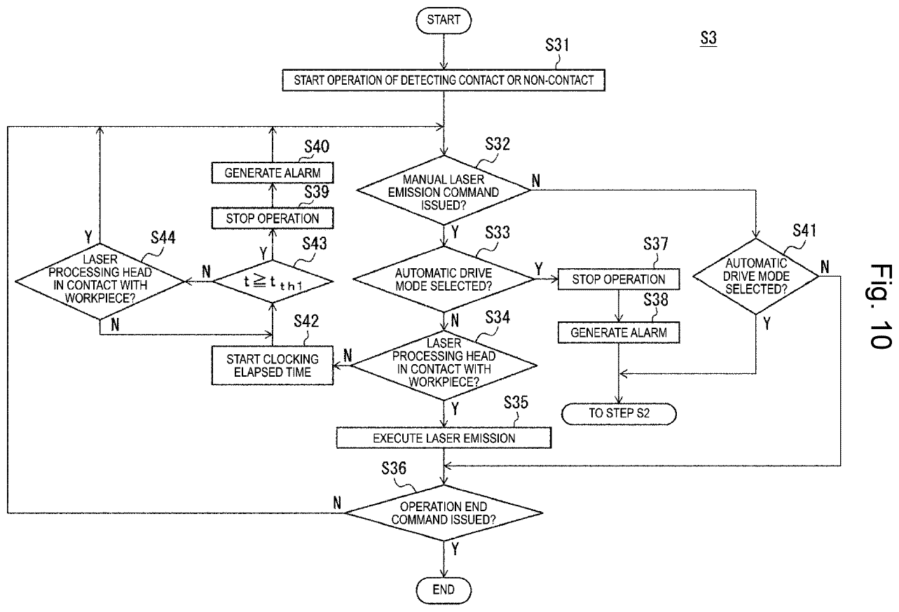

The processor 40 of the controller 18 illustrated in FIG. 9 executes the flow of FIG. 10 as step S3 in FIG. 6. Note that, in the flow shown in FIG. 10, processes similar to those in the flow of FIG. 8 are denoted by the same step numbers, and redundant description is omitted. Here, in the present embodiment, the processor 40 sets in advance a standby time tₜₕ₁ from a time point t₀ when non-contact between the laser processing head 14 and the workpiece W is detected by the contact detection device 60 (i.e., NO is determined in step S34) to when the laser emission operation LO is to be stopped in step S39.

For example, the operator operates the input device 48 of the controller 18 to input the standby time tₜₕ₁ (e.g., tₜₕ₁=0.3 [sec]). The processor 40 stores the input standby time tₜₕ₁ into the memory 42 and registers it as standby time setting information. Thus, the processor 40 sets the standby time tₜₕ₁ in advance.

In step S3 shown in FIG. 10, when determining NO in step S34, the processor 40 starts clocking of the elapsed time t in step S42. Specifically, the processor 40 activates the clocking section 64 to start clocking of the elapsed time t from the time point t₀ at which NO is determined in step S34.

In step S43, the processor 40 determines whether or not the elapsed time t being clocked by the clocking section 64 has reached the standby time tₜₕ₁ set in advance (i.e., t≥tₜₕ₁). The processor 40 determines YES when t≥tₜₕ₁ and proceeds to step S39, and determines NO when t<tₜₕ₁ and proceeds to step S44

In step S44, the processor 40 determines whether or not the contact between the laser processing head 14 and the workpiece W has been detected by the contact detection device 60, similarly to step S34 described above. The processor 40 returns to step S32 when determining YES, and returns to step S43 when determining NO (i.e., when the laser processing head 14 and the workpiece W are still in non-contact with each other).

Technical significance of steps S42 to S44 will be described below. According to steps S42 to S44, when determining NO in step S34 while continuing the laser emission operation LO (i.e., while continuing determination of YES in step S32) after the execution of step S35, the processor 40 does not execute step S39 (in other words, continues the laser emission operation LO) until the standby time tₜₕ₁ elapses from the time point t₀ when determining NO in step S34 (i.e., until determining YES in step S43).

Then, when continuously determining NO in step S44 before the standby time tₜₕ₁ elapses (i.e., when non-contact between the laser processing head 14 and the workpiece W is continuously detected over the period tₜₕ₁), the processor 40 stops the laser emission operation LO in step S39. On the other hand, when determining YES in step S44 before the standby time tₜₕ₁ elapses, the processor 40 continues the laser emission operation LO without executing step S39.

As described above, in the present embodiment, the controller 18 sets the standby time tₜₕ₁ from the time point t₀ when the contact detection device 60 detects non-contact to when the laser emission operation LO is to be stopped, when the laser emission operation LO is being executed in the manual drive mode DM1. Then, the controller 18 stops the laser emission operation LO in the manual drive mode DM2 when the standby time tₜₕ₁ has elapsed from the time point t₀.

Here, in the manual drive mode DM2, the operator may execute the laser process with the laser beam LB emitted from the laser processing head 14 while moving the laser processing head 14 relative to the workpiece W and bringing the distal end of the laser processing head 14 into contact with the workpiece W.

In this case, the laser processing head 14 can be instantaneously (e.g., only 0.1 [sec]) separated from the workpiece W by the uneven portion on the surface of the workpiece W, for example. Even if the laser processing head 14 is instantaneously separated from the workpiece W in this manner, there is a low possibility that the laser beam LB from the laser processing head 14 is emitted in the direction of the operator, and hence the safety of the operator can be ensured.

According to the present embodiment, by setting the standby time tₜₕ₁ until the laser emission operation LO is to be stopped in step S39, the laser emission operation LO can be continued even if the above-described instantaneous separation of the laser processing head 14 from the workpiece W occurs. On the other hand, when non-contact between the laser processing head 14 and the workpiece W is still detected even after the standby time tₜₕ₁ has elapsed, the laser emission operation LO can be stopped by immediately executing step S39. Therefore, according to the present embodiment, the laser processing work in the manual drive mode DM2 can be efficiently performed, and the safety of the operator can be reliably ensured.

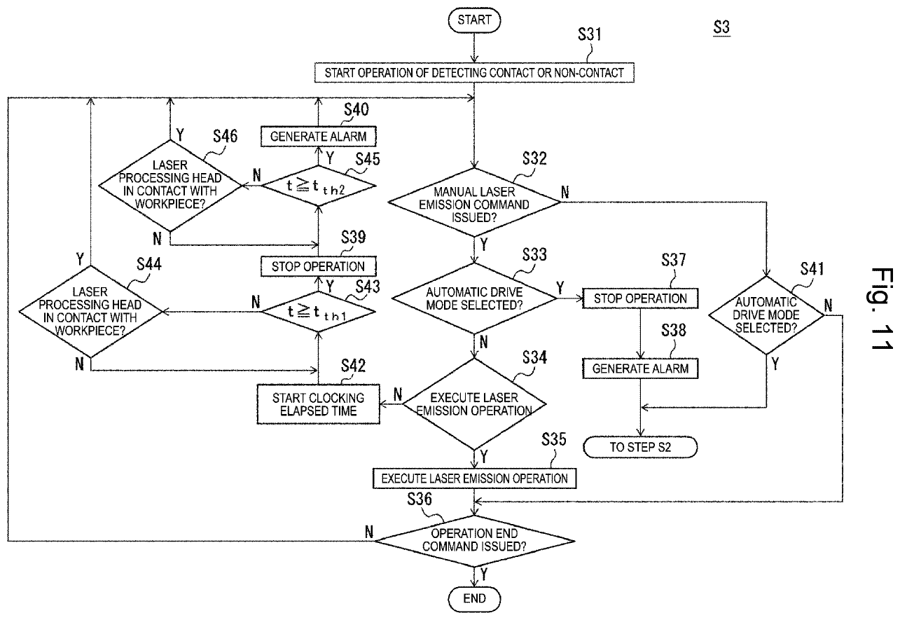

Next, another flow of step S3 executed by the controller 18 illustrated in FIG. 9 will be described with reference to FIG. 11. In the present embodiment, in addition to the above-described standby time tₜₕ₁, the processor 40 sets in advance a second standby time tₜₕ₂ from the time point t₀ at which NO is determined in step S34 to when the alarm signal AL is generated in step S40.

For example, the operator operates the input device 48 of the controller 18 to input the second standby time tₜₕ₂ as a time tₜₕ₂ (tₜₕ₂>tₜₕ₁) longer than the standby time tₜₕ₁ (e.g., tₜₕ₂=0.4 [sec]). The processor 40 stores the input second standby time tₜₕ₂ into the memory 42, and registers it as standby time setting information together with the standby time tₜₕ₁.

FIG. 11 shows the flow of step S3 according to the present embodiment. Note that, in the flow shown in FIG. 11, processes similar to those in the flow of FIG. 10 are denoted by the same step numbers, and redundant description is omitted. In the flow of FIG. 11, after stopping the laser emission operation LO in step S39, the processor 40 further executes steps S45 and S46.

Specifically, in step S45, the processor 40 determines whether or not the elapsed time t being clocked by the clocking section 64 has reached the second standby time tₜₕ₂ set in advance (i.e., t≥tₜₕ₂). The processor 40 determines YES and proceeds to step S40 when t≥tₜₕ₂, and determines NO and proceeds to step S46 when tₜₕ₁≤t<tₜₕ₂.

In step S46, the processor 40 determines whether or not the contact between the laser processing head 14 and the workpiece W has been detected by the contact detection device 60, similarly to step S44 described above. The processor 40 returns to step S32 when determining YES and returns to step S45 when determining NO.

Thus, in the present embodiment, after step S39, the processor 40 does not execute step S40 until another period t′=tₜₕ₂−tₜₕ₁ elapses. According to this configuration, the alarm signal AL5 can be generated and notified to the operator only when the non-contact between the laser processing head 14 and the workpiece W is detected for a long period. This can prevent the alarm signal ALS from being frequently transmitted.

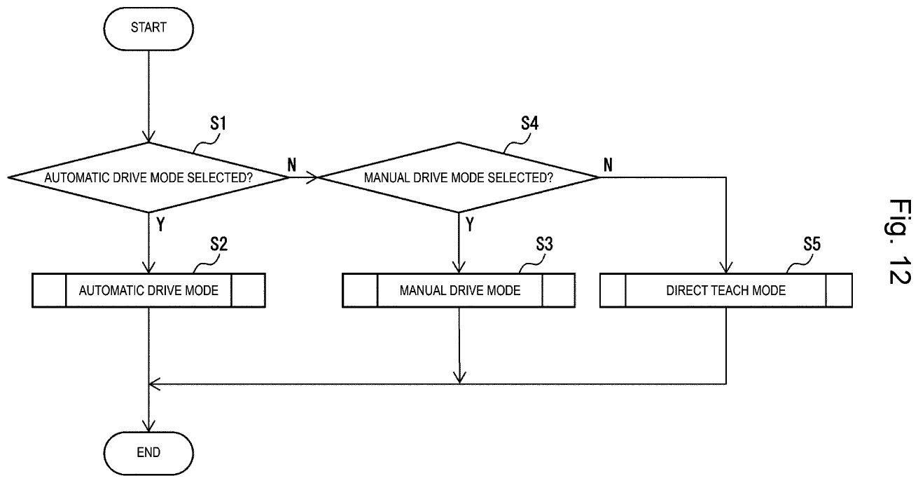

Next, still another example of the operation flow of the laser processing system 10 illustrated in FIG. 9 will be described with reference to FIG. 12. In the present embodiment, the processor 40 executes a direct teach mode DM3 in addition to the automatic drive mode DM1 and the manual drive mode DM2 described above. The direct teach mode DM3 is the drive mode DM in which the processor 40 operates the robot 12 in accordance with the external force F applied to the robot 12 by the operator, and executes the laser emission operation LO in response to the manual laser emission command CM2 input by the operator through the input device 58.

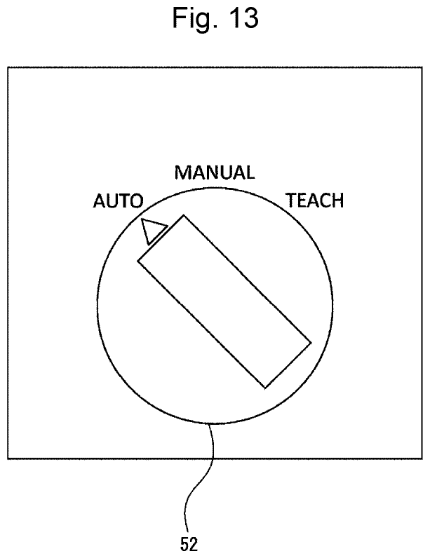

As illustrated in FIG. 13, in the present embodiment, the mode selection switch 52 is configured to be switchable among the automatic drive mode DM1: “AUTO”, the manual drive mode DM2: “MANUAL”, and a direct teach mode DM3 represented as “TEACH”. When the direct teach mode DM3 is selected by the mode selection switch 52, the mode selection switch 52 supplies a direct teach mode transition command CM5 to the controller 18.

Hereinafter, an operation flow of the laser processing system 10 according to the present embodiment will be described with reference to FIG. 12. Note that, in the flow shown in FIG. 12, processes similar to those in the flow of FIG. 6 are denoted by the same step numbers, and redundant description is omitted. In the flow shown in FIG. 12, when determining NO in step S1, the processor 40 determines in step S4 whether or not the manual drive mode DM2 is selected or the direct teach mode DM3 is selected by the mode selection switch 52.

Specifically, when receiving the manual drive mode transition command CM4 from the mode selection switch 52, the processor 40 determines YES, and proceeds to step S3. On the other hand, when receiving the direct teach mode transition command CM5 from the mode selection switch 52, the processor 40 determines NO and proceeds to step S5.

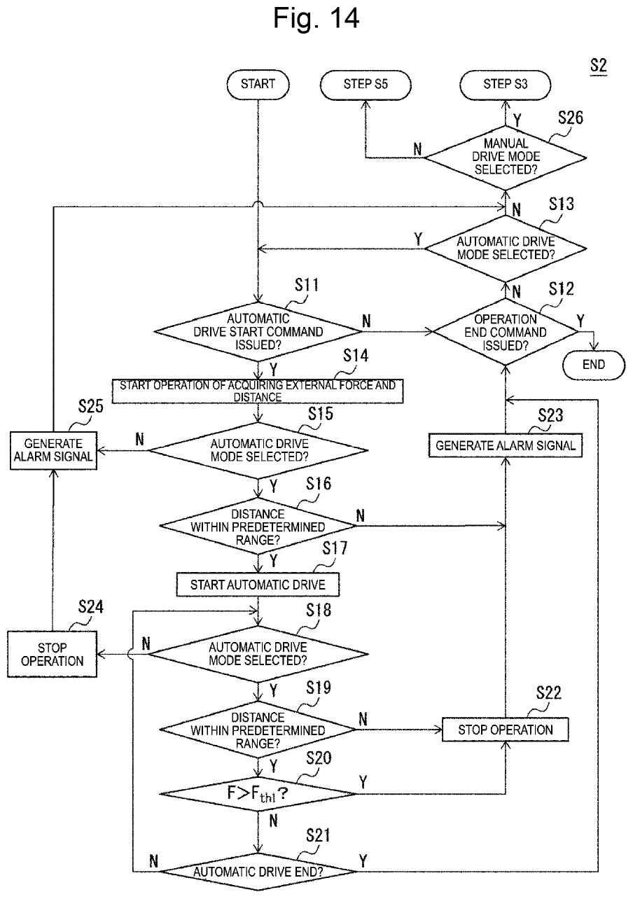

FIG. 14 shows the flow of step S2 in FIG. 12. Note that, in the flow shown in FIG. 14, processes similar to those in the flow of FIG. 7 are denoted by the same step numbers, and redundant description is omitted. In the flow shown in FIG. 14, when determining NO in step S13, the processor 40 determines in step S26 whether or not the manual drive mode DM2 is selected or the direct teach mode DM3 is selected by the mode selection switch 52, similarly to step S4 described above.

The processor 40 determines YES and proceeds to step S3 in FIG. 12 when the manual drive mode DM2 is selected, and determines NO and proceeds to step S5 in FIG. 12 when the direct teach mode DM3 is selected. After step S25, the processor 40 proceeds to step S26.

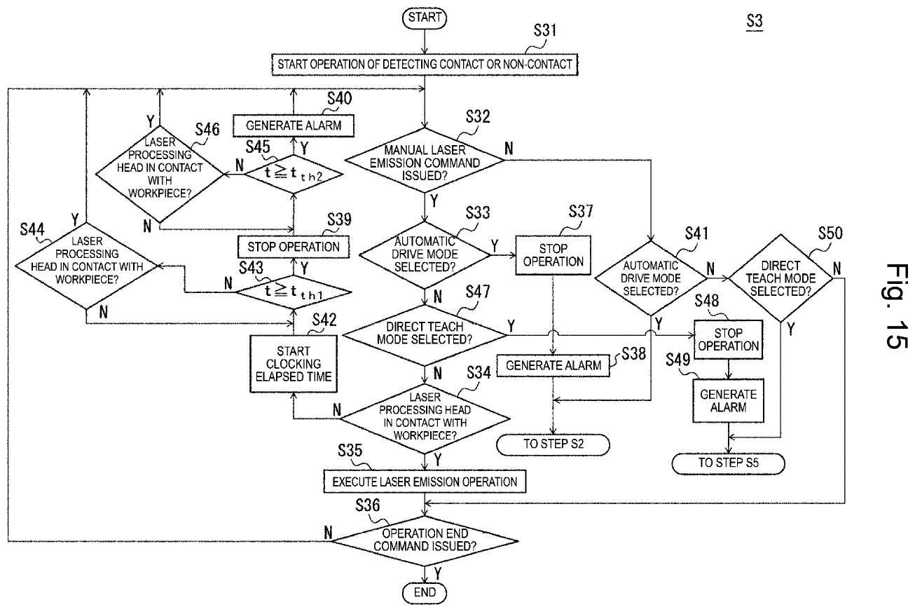

FIG. 15 shows the flow of step S3 in FIG. 12. Note that, in the flow shown in FIG. 15, processes similar to those in the flow of FIG. 11 are denoted by the same step numbers, and redundant description is omitted. In the flow shown in FIG. 15, when determining NO in step S33, the processor 40 determines whether or not the direct teach mode DM3 is selected (i.e., the direct teach mode transition command CM5 is received) in step S47. The processor 40 proceeds to step S48 when determining YES, and proceeds to step S34 when determining NO.

In step S48, the processor 40 stops the laser emission operation LO in the manual drive mode DM2, similarly to step S37 described above. Then, in step S49, the processor 40 generates the alarm signal AL4 similarly to step S38 described above, and then proceeds to step S5 in FIG. 12.

On the other hand, when determining NO in step S41, the processor 40 determines in step S50 whether or not the direct teach mode DM3 is selected, similarly to step S47 described above. The processor 40 proceeds to step S5 in FIG. 12 when determining YES, and proceeds to step S36 when determining NO.

With reference to FIG. 12 again, when determining NO in step S4 (alternatively, when determining NO in step S26 in FIG. 14, after step S49 in FIG. 15, or when determining YES in step S50 in FIG. 15), the processor 40 transitions the drive mode DM to the direct teach mode DM3 and executes the flow of the direct teach mode DM3 in step S5.

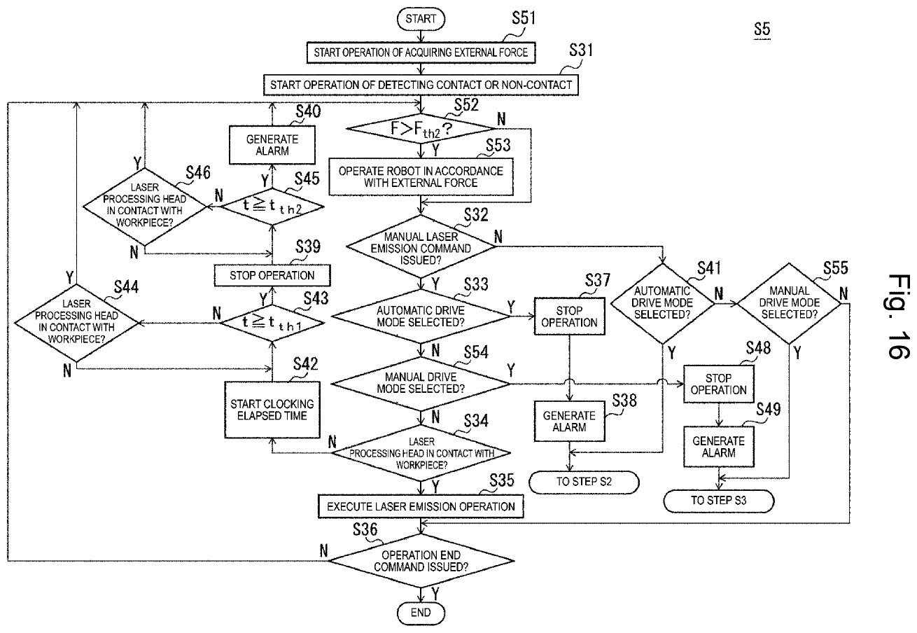

After transitioning to the direct teach mode DM3, the processor 40 is brought into a state of being able to receive the manual laser emission command CM2 through the input device 58, and rejects the automatic drive start command CM1. Hereinafter, the flow of the direct teach mode DM3 in step S5 will be described with reference to FIG. 16. Note that, in the flow shown in FIG. 16, processes similar to those in the flow of FIG. 15 are denoted by the same step numbers, and redundant description is omitted.

In step S51, the processor 40 starts an operation of acquiring the external force F applied to the robot 12. Specifically, the processor 40 continuously (e.g., periodically) acquires the detection data DF from the force sensor 54, and continuously obtains the magnitude and direction of the external force F applied to the robot 12 and the part of the robot 12 applied with the external force F based on the detection data DF. Thereafter, the processor 40 executes step S31 described above.

After step S31, in step S52, the processor 40 determines whether or not the magnitude of the external force F acquired most recently exceeds a predetermined threshold Fₜₕ₂ (F>Fₜₕ₂). This threshold Fₜₕ₂ may be set to a value (Fₜₕ₂<Fₜₕ₁) smaller than the threshold Fₜₕ₁ referred to in step S20 (FIG. 7 and FIG. 14) described above. The processor 40 determines YES when F>Fₜₕ2, and proceeds to step S53, and determines NO when F≤Fₜₕ₂, and proceeds to step S32.

In step S53, the processor 40 operates the robot 12 according to the most recently acquired external force F. Specifically, the processor 40 generates a command (torque command or the like) for moving, in the direction of the external force F, a part (e.g., wrist 28) of the robot 12 applied with the most recently acquired external force F, and drives each servomotor 30 of the robot 12 in accordance with the command. As a result, the robot 12 moves, in the direction of the external force F, the part applied with the external force F in accordance with the external force F.

For example, it is assumed that the operator grips the grip 38 of the laser processing head 14, applies an external force F to the laser processing head, and pushes the laser processing head 14 in a desired direction φ. The external force F applied in the direction φ in this manner is applied from the laser processing head 14 to the wrist flange 28b of the robot 12, and is detected by the force sensor 54.

In this case, the processor 40 operates the robot 12 in accordance with the external force F detected by the force sensor 54 to move the wrist flange 28b (i.e., the laser processing head 14) of the robot 12 in the direction φ. Thus, the operator can manually operate the robot 12 to move the laser processing head 14 in the desired direction φ by the operation of the robot 12.

In step S53, the processor 40 may move the part (e.g., wrist flange 28b) of the robot 12 applied with the external force F by a predetermined distance 8 at a predetermined constant speed V. The speed V and the distance 8 can be determined in advance by the operator as required values for the direct teach mode DM3.

After step S53, the processor 40 executes steps S32 and S33 described above. When determining NO in step S33, the processor 40 determines whether or not the manual drive mode DM2 is selected (i.e., the manual drive mode transition command CM4 is received) in step S54. When determining YES, the processor 40 sequentially executes steps S48 and S49 described above, and proceeds to step S3 in FIG. 12.

On the other hand, when determining NO in step S54, the processor 40 sequentially executes steps S34 to 36, S42 to S44, S39, S45, S46, and S40 described above. When determining NO in step S36, when determining YES in step S44 or S46, or after executing step S40, the processor 40 returns to step S52.

On the other hand, when determining NO in step S41, the processor 40 determines in step S55 whether or not the manual drive mode DM2 is selected similarly to step S54 described above. The processor 40 proceeds to step S3 in FIG. 12 when determining YES, and proceeds to step S36 when determining NO.

Thus, in the direct teach mode DM3 in step S5 shown in FIG. 16, the processor 40 operates the robot 12 in accordance with the external force F applied by the operator (step S53), and executes the laser emission operation LO in accordance with the manual laser emission command CM2 input by operating the input device 58 by the operator while moving the laser processing head 14 in the direction φ (step S35).

By this, the operator manually operates the robot 12 to move the laser processing head 14 in the desired direction φ by the operation of the robot 12, and operates the input device 58 to manually emit the laser beam LB from the laser processing head 14, thereby performing the laser process on the workpiece W. At this time, the robot 12 may move the laser processing head 14 at the constant speed V as described above. According to this configuration, the final quality of the laser process can be improved.

When the laser processing head 14 and the workpiece W are in non-contact with each other for the standby time tₜₕ₁ while the laser process is executed in the direct teach mode DM3 (YES is determined in step S43), the laser emission operation LO can be stopped in step S39. Therefore, the safety of the operator can also be ensured.

Note that steps S45 and S46 may be omitted from the flow shown in FIG. 16 and configured similarly to the flow of FIG. 10. Alternatively, steps S42 to S46 may be omitted from the flow shown in FIG. 16 and configured similarly to the flow of FIG. 8. When steps S42 to S46 are omitted from the flow shown in FIG. 16, the controller 18 shown in FIG. 2 in which the clocking section 64 is left out can execute the flow of FIG. 16.

In the flow of step S5 shown in FIG. 16, step S19 shown in FIG. 14 may be applied instead of step S34, and steps S42 to S44, S45, S46, and S40 may be omitted. In this case, step S31 is omitted from the flow of FIG. 16, and in step S51, the processor 40 starts the operation of acquiring the external force F and the distance d similarly to step S14 of FIG. 14. Then, when determining NO in step S54, the processor 40 executes step S19 and determines whether or not the distance d is within the range RG. When the distance d is within the range RG, the processor 40 determines YES, and proceeds to step S35.

On the other hand, when the distance d is out of the range RG, the processor 40 determines NO, executes step S39 to stop the laser emission operation LO, and then executes step S23 described above to generate the alarm signal AL1. Thereafter, the processor 40 returns to step S52. That is, in this case, the processor 40 stops the laser emission operation LO when the distance d between the laser processing head 14 and the workpiece W is out of the predetermined range RG while executing the laser emission operation LO (step S35) in the direct teach mode DM3.

In step S2 (the flow of the automatic drive mode DM1) described above, after starting the automatic drive in step S17, the processor 40 may execute gap control GC of controlling the distance d between the laser processing head 14 and the workpiece W to a predetermined target distance d₀. This target distance d₀ can be determined by the operator as, for example, a value (e.g., dₜₕ₁<d₀ <dₜₕ₂) in the range RG referred to in steps S16 and S19.

In this gap control GC, the processor 40 feedback-controls each servomotor 30 of the robot 12 based on the distance d acquired from the distance measurement sensor 56, and adjusts the position in the direction of the optical axis A of the laser processing head 14 by the operation of the robot 12 so that the distance d matches the target distance d₀.

Note that the processor 40 may execute the flow of FIG. 6, the flow of step S2 shown in FIG. 7, and the flow of step S3 shown in FIG. 8, 10, or 11 in accordance with the operation program OP. This operation program OP may be created in advance by the operator and stored in the memory 42 as a program different from the processing program PP described above.

In this case, the processor 40 executes the flow of step S2 in FIG. 7 in accordance with the operation program OP, and reads, from the memory 42, and executes the processing program PP when step S17 is started, thereby starting the automatic drive of the laser emission operation LO and the movement operation MO.

A gap control program GP for the gap control GC described above may be further prepared. In this case, when starting step S17, the processor 40 executes the gap control program GP in parallel with the processing program PP, and executes the gap control GC in parallel with the automatic drive.

The operation program OP may include a first operation program OP1 that causes the processor 40 to execute the flow of FIG. 6, a second operation program OP2 that causes the processor 40 to execute the flow of step S2, and a third operation program OP3 that causes the processor 40 to execute the flow of step S3.

Similarly, the processor 40 may execute the flow of FIG. 12, the flow of step S2 shown in FIG. 14, the flow of step S3 shown in FIG. 15, and the flow of step S5 shown in FIG. 16 in accordance with the operation program OP. In this case, the operation program OP may include the first operation program OP1 that causes the processor 40 to execute the flow of FIG. 12, the second operation program OP2 that causes the processor 40 to execute the flow of step S2, the third operation program OP3 that causes the processor 40 to execute the flow of step S3, and a fourth operation program OP4 that causes the processor 40 to execute the flow of step S5.

Note that the input device 58 need not be provided at the laser processing head 14, and may be configured as, for example, a portable button device that can be carried by the operator or a foot pedal (or a foot switch) that the operator can perform an input operation with a foot, separately from the laser processing head 14. The distance measurement sensor 56 need not be provided at the laser processing head 14, and may be provided adjacent to the workpiece W, for example.

The laser processing system 10 may further include a second input device configured to receive an input operation of an assist gas emission command for causing the laser processing head 14 to emit the assist gas AG in the manual drive mode DM2 in step S3. When the operator operates the second input device at the time of executing the manual drive mode DM2, the processor 40 operates the assist gas supply device in response to the assist gas emission command transmitted from the second input device, and supplies the assist gas AG to the laser processing head 14. In this case, the second input device may be provided at the laser processing head 14 adjacent to the grip 38 so as to enable the input operation with the one hand gripping the grip 38.

The mode selection switch 52 is not limited to the controller 18, and may be provided at any component. For example, the mode selection switch 52 may be provided at the laser processing head 14, or may be configured as a portable switch that is provided separately from the controller 18 and can be carried by the operator. Alternatively, the mode selection switch 52 may be communicatively connected to the controller 18 and provided at a teaching device (teaching pendant, tablet terminal device, and the like) for teaching operation to the robot 12 and the laser oscillator 16.

Note that, in the above-described embodiment, the case where the mode selection switch 52 is provided at the controller 18 as a physical switch has been described. However, the mode selection switch 52 may be implemented in the controller 18 as a software switch (alternatively, a virtual switch).

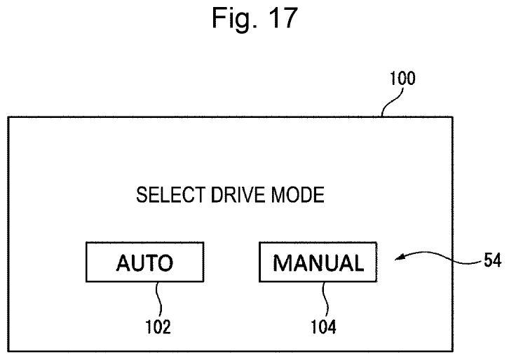

For example, the processor 40 of the controller 18 generates and displays, on the display device 50, a mode selection switch image 100 for selecting the drive mode DM. FIG. 17 illustrates an example of the mode selection switch image 100. The mode selection switch image 100 is a graphical user interface (GUI) for enabling the operator to select the drive mode DM, and includes an automatic drive button image 102 and a manual drive button image 104.

The automatic drive button image 102 represented as “AUTO” corresponds to the automatic drive mode DM1, and the manual drive button image 104 represented as “MANUAL” corresponds to the manual drive mode DM2. The operator can select the automatic drive mode DM1 or the manual drive mode DM2 by operating the input device 48 and clicking, on the image, the automatic drive button image 102 or the manual drive button image 104 while visually recognizing the mode selection switch image 100 displayed on the display device 50 of the controller 18.

Upon receiving an input for selecting the automatic drive button image 102 (i.e., the automatic drive mode transition command CM3) from the operator through the input device 48, the processor 40 transitions the drive mode DM to the automatic drive mode DM1 (step S2 described above). On the other hand, upon receiving an input (i.e., the manual drive mode transition command CM4) for selecting the manual drive button image 104 from the operator through the input device 48, the processor 40 transitions the drive mode DM to the manual drive mode DM2 (step S3 described above).

As described above, the automatic drive button image 102 and the manual drive button image 104 constitute the mode selection switch 52 as software, and the operator can switch the drive mode DM between the automatic drive mode DM1 and the manual drive mode DM2 by operating the mode selection switch 52 on the image.

It should be understood that the mode selection switch 52 as software can be configured to select the automatic drive mode DM1, the manual drive mode DM2, or the direct teach mode DM3. The mode selection switch 52 as software is not limited to the controller 18, and may be implemented on the teaching device described above or any other communication device (PC, tablet terminal) communicably connected to the controller 18.

In the above embodiment, the automatic drive mode DM1, the manual drive mode DM2, and the direct teach mode DM3 are exemplified as the drive mode DM. However, the drive mode DM is not limited to this, and may include any other drive mode DM such as a teach mode DM4 for teaching the operation to the robot 12 and the laser oscillator 16.

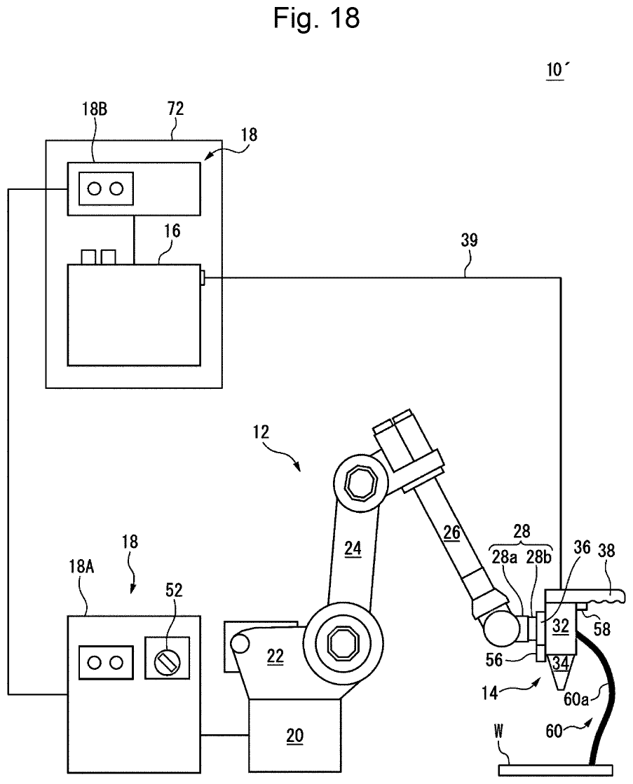

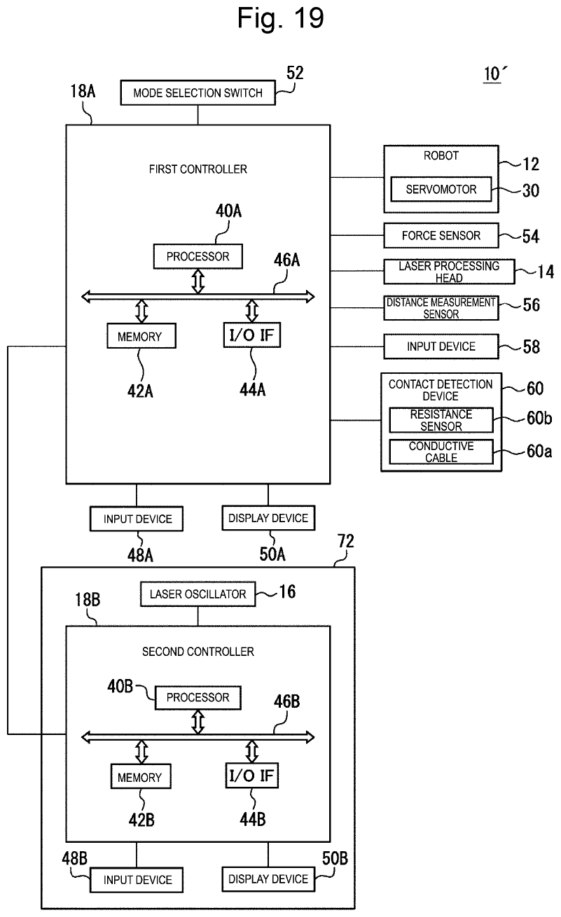

In addition, in the embodiments described above, the case is described where the controller 18 controls the robot 12 and the laser oscillator 16. Alternatively, the controller 18 may include a first controller 18A configured to control the robot 12 and a second controller 18B configured to control the laser oscillator 16. Such a form is illustrated in FIGS. 18 and 19.

In a laser processing system 10′ illustrated in FIGS. 18 and 19, the controller 18 includes the first controller 18A configured to control the movement operation MO of the robot 12 and the second controller 18B configured to control the laser emission operation LO of the laser oscillator 16. The first controller 18A is a computer including a processor 40A, a memory 42A, an I/O interface 44A, and a bus 46A.

The robot 12 (servomotor 30), the laser processing head 14 (lens drive part), an input device 48A, a display device 50A, the force sensor 54, the distance measurement sensor 56, the input device 58, and the contact detection device 60 (resistance sensor 60b) are communicably connected to the I/O interface 44A of the first controller 18A. The mode selection switch 52 described above is provided at the first controller 18A.

The second controller 18B is a computer including a processor 40B, a memory 42B, an I/O interface 44B, and a bus 46B. An input device 48B, a display device 50B, the laser oscillator 16, and the I/O interface 44A of the first controller 18A are communicably connected to the I/O interface 44B of the second controller 18B.

Note that the laser oscillator 16, the second controller 18B, the input device 48B, and the display device 50B may be integrated into a common housing to be unitized to constitute a single laser oscillation device 72. The processor 40A of the first controller 18A and the processor 40B of the second controller 18B may execute the flows illustrated in FIGS. 6 to 8, 10 to 12, and 14 to 16 while communicating with each other.

The laser processing head 14 may be any type of processing head such as a laser scanner (alternatively, a galvano scanner). This laser scanner includes a plurality of mirrors that each reflect the laser beam LB supplied from the laser oscillator 16, a plurality of mirror drive parts that individually drive the plurality of mirrors, and an optical lens that condenses the laser beam reflected by the mirrors. The laser scanner can move an irradiation point of the laser beam with which the workpiece is irradiated, at a high speed on the surface of the workpiece W by changing the orientations of the plurality of mirrors by the mirror drive part.

Note that the robot 12 is not limited to the vertical articulated robot, and may be, for example, a horizontal articulated robot or a parallel link robot, and may be configured to include first and second ball screw mechanisms that move the workpiece W in the horizontal plane, and a third ball screw mechanism configured to move the laser processing head 14 in the vertical direction. The light guide path 39 may be left out from the laser processing system 10 or 10′. In this case, the laser oscillator 16 may be directly coupled to the laser processing head 14. Although the present disclosure has been described through embodiments above, the embodiments described above do not limit the scope of the invention claimed in the claims.

### REFERENCE SIGNS LIST

10, 10′ Laser processing system
12 Robot
14 Laser processing head
16 Laser oscillator
18 Controller
40, 40A, 40B Processor
48, 48A, 48B, 58 Input device
52 Mode selection switch
54 Force sensor
56 Distance measurement sensor
60 Contact detection device

1. A laser processing system configured to perform a laser process on a workpiece, the laser processing system comprising:
a laser processing head configured to emit a laser beam generated by a laser oscillator;
a robot configured to move the laser processing head relative to the workpiece;
a distance measurement sensor configured to measure a distance between the laser processing head and the workpiece;
a controller configured to control a laser emission operation of operating the laser oscillator to emit a laser beam from the laser processing head, and a movement operation of operating the robot to move the laser processing head relative to the workpiece; and
a mode selection switch configured to select a drive mode of the laser process,
wherein the controller is configured to, when an automatic drive mode, in which the laser emission operation and the movement operation are automatically executed in accordance with a processing program, is selected as the drive mode by the mode selection switch, and when the distance measured by the distance measurement sensor is within a predetermined range, execute the laser emission operation and the movement operation as the automatic drive mode.

2. The laser processing system of claim 1, further comprising:
an input device configured to receive an input operation of a manual laser emission command for causing the controller to execute the laser emission operation; and
a contact detection device configured to detect contact or non-contact between the laser processing head and the workpiece,
wherein the mode selection switch is configured to switch the drive mode between the automatic drive mode and a manual drive mode in which the controller executes the laser emission operation in response to the manual laser emission command, and
wherein the controller is configured to execute the laser emission operation as the manual drive mode in response to the manual laser emission command received through the input device, when the manual drive mode is selected by the mode selection switch and the contact detection device detects the contact.

3. The laser processing system of claim 2, wherein the contact detection device includes:
a conductive cable electrically connecting the laser processing head and the workpiece; and
a resistance sensor configured to measure resistance of a closed circuit formed by the workpiece, the laser processing head in contact with the workpiece, and the conductive cable,
wherein the contact detection device is configured to detect the contact or the non-contact based on the resistance measured by the resistance sensor.

4. The laser processing system of claim 2, wherein the controller is configured to stop the laser emission operation when the mode selection switch is operated to deselect the manual drive mode or the contact detection device detects the non-contact, during execution of the laser emission operation in the manual drive mode.

5. The laser processing system of claim 2, wherein the controller is configured to:
set a standby time from a time point when the contact detection device detects the non-contact during execution of the laser emission operation in the manual drive mode to when the laser emission operation is to be stopped; and
stop the laser emission operation in the manual drive mode when the standby time from the time point elapses.

6. The laser processing system of claim 2, wherein the laser processing head includes a grip that is grippable by an operator with one hand, and
wherein the input device is provided at the laser processing head adjacent to the grip so as to enable the input operation with the one hand gripping the grip.

7. The laser processing system of claim 1, wherein the controller is configured not to start at least one of the laser emission operation and the movement operation as the automatic drive mode, when the automatic drive mode is deselected by the mode selection switch or the distance measured by the distance measurement sensor is out of the range when the controller receives an automatic drive start command for starting the automatic drive mode.

8. The laser processing system of claim 1, wherein the controller is configured to stop at least one of the laser emission operation and the movement operation when the mode selection switch is operated to deselect the automatic drive mode or the distance measured by the distance measurement sensor is out of the range, during execution of the laser emission operation and the movement operation as the automatic drive mode.

9. The laser processing system of claim 1, wherein the controller is configured to execute gap control for operating the robot such that the distance matches a predetermined target distance, based on the distance measured by the distance measurement sensor, during execution of the laser emission operation and the movement operation as the automatic drive mode.

10. A method of performing a laser process using the laser processing system of claim 1, the method comprising:
determining, by the controller, whether or not the automatic drive mode is selected by the mode selection switch;
determining, by the controller, whether or not the distance measured by the distance measurement sensor is within the range; and
executing, by the controller, the laser emission operation and the movement operation as the automatic drive mode, when the automatic drive mode is selected by the mode selection switch and the distance measured by the distance measurement sensor is within the range.
